(19) United States
(12) Patent Application Publication
(10) Pub. No.: US 2025/0006941 A1
(43) Pub. Date: Jan. 2, 2025

(54) New conductive additive in lithium and sodium batteries

(71) Applicant: CarbonX IP 10 B.V., Amsterdam (NL)

(72) Inventors: Rutger Alexander David van Raalten, Amsterdam (NL); Daniela Sordi, Amsterdam (NL); Jeroen ten Dam, Amsterdam (NL)

(73) Assignee: CarbonX IP 10 B.V., Amsterdam (NL)

(21) Appl. No.: 18/704,078

(22) PCT Filed: Oct. 25, 2022
(86) PCT No.: PCT/EP2022/079747

§ 371 Date: Apr. 24, 2024

(30) Foreign Application Priority Data
Oct. 26, 2021 (EP) 21204834.2

(51) Int. Cl. H01M 4/62; H01M 4/02; H01M 4/583; H01M 10/0525; H01M 10/054

(52) U.S. Cl. CPC H01M 4/625; H01M 4/583; H01M 10/0525; H01M 10/054; H01M 2004/021; H01M 2004/027; H01M 2220/30

(57) ABSTRACT

The invention pertains to the use of porous, chemically interconnected, carbon nanofibres-comprising carbon networks as a conductive additive in lithium or sodium batteries. It has been found that said carbon-nanofibre comprising carbon networks can beneficially be used in the cathode of lithium or sodium batteries when added in an amount of 0.1-20 wt %, and/or in the anode of lithium or sodium batteries when added in an amount of 0.1-10 wt %. The benefits include a high lifetime (stability over extended cycling), high charge and discharge rate and being resilient during manufacture and use. The porous, chemically interconnected, carbon nanofibres-comprising carbon networks can be used as conductive additive in the anode and/or cathode of lithium or sodium batteries of many areas of technology, such as smartphones, laptops and electric and hybrid vehicles.

### FIELD OF THE INVENTION

The present invention is in the field of lithium and sodium batteries. More particularly, the present invention relates to conductive additives in the anode and/or cathode of rechargeable lithium and sodium batteries. The invention preferably relates to sodium-ion and lithium-ion batteries, most preferably lithium-ion batteries (including lithium-sulfur batteries).

### BACKGROUND TO THE INVENTION

Although there are different kinds of batteries available, nowadays lithium is the first choice for negative electrode material. The reason lies in the specific capacity for lithium which is much higher than that of for example zinc and lead. It is the lightest, most electropositive metal with high energy and power density. The demand for lithium batteries or ‘lithium secondary batteries’ keeps increasing, especially as power sources for portable electronic devices such as smartphones or laptops (including their liquid crystal display (LCD) or organic light emitting diodes (OLED)), power plant energy storage (i.e. from surplus wind and solar renewable energy), Uninterruptible Power Supply (UPS) and as power sources for driving motors of electric and hybrid vehicles.

Although lithium batteries are the most widely used power batteries, the production of lithium batteries faces great challenges, such as an increasing shortage of lithium resources, the rising price of upstream materials and a low recycling rate. In order to overcome these challenges of lithium batteries, sodium batteries, making use of an intercalation process of sodium ions between a positive electrode and a negative electrode, make a solid alternative choice. The advantages of sodium batteries are that the reserve of sodium resources is far more abundant than that of lithium, the distribution is more extensive, and the cost of sodium is far lower than that of lithium; for these reasons, sodium batteries have the potential to replace lithium batteries, insofar as issues such as their low coulombic efficiency and poor rate capability are overcome or reduced to satisfactory proportions.

Lithium and sodium batteries are typically composed of four major components: cathode, anode, separator and electrolyte. The electrolyte serves as a conductive medium through which lithium ions can be transported to and from the electrodes. The electrolyte can be either solid-state or liquid. In the context of the invention, a ‘lithium battery’ or ‘sodium battery’ includes both solid state (with solid electrolyte) and liquid state (with liquid electrolyte) batteries. In the context of the invention, the terms ‘lithium-ion battery’ and ‘sodium-ion battery’ are reserved for battery technology with a liquid electrolyte.

The cathode of lithium batteries generally comprises a Lithium-Metal-Oxide (e.g. lithium cobalt oxide (LiCoO₂)). The cathode of lithium batteries may also comprise sulfur or a sulfur composite. Lithium-sulfur (Li—S) batteries have attracted increasing interest in the art, because they have the advantage of having high theoretical capacity and specific energy. However, sulfur has low electric conductivity. Moreover, Li—S batteries are known to easily degrade due to a process commonly known as the polysulfide “shuttle effect”. The materials commonly used as active materials in the anode of lithium batteries are intercalation compounds, metal alloys and conversion compounds (transition-metal oxides). The most common of the intercalation compounds used in the anode of a lithium battery is graphite. Another common compound used in the anode of lithium batteries is silicon or silicon-based compounds. Generally silicon materials have high specific capacity compared to graphite. All in all, hitherto graphite remains the dominant intercalation anode material in commercial lithium batteries; this is because the performance of graphite is safe and provides sufficient energy density for many portable power applications, as well as low working potential, low cost and good cycle life. However, a battery with a graphite anode usually has moderate power density due to the relatively slow diffusion rate of lithium ion into carbon materials (between 10⁻¹² and 10⁻⁶ cm²/s); this feature, together with a suboptimal electron conductivity, results in charge/discharge rates of graphite alone being not optimal, and thus in long charging and discharging times of the battery.

To improve the charge/discharge rates of the battery, conductive additives are traditionally added to graphite to improve the electron conductivity of the anode (Roselin et al., “Recent Advances and Perspectives of Carbon-Based Nanostructures as Anode Materials for Li-ion Batteries”, Materials 2019, 12, 1229). These additives construct a conductive percolation network to increase and keep the electronic conductivity of electrode, enabling it charge and discharge faster. In addition, conductive additives absorb and retain electrolyte, allowing an intimate contact between the lithium ions and active materials. The conductive additive for lithium batteries is commonly a carbon nanomaterial selected from carbon black, Super P, acetylene black, carbon nanofibers, and carbon nanotubes, all presenting low weight, high chemical inertia and high specific surface area (Zhang Q et al., “Carbon nanomaterials used as conductive additives in lithium ion batteries”, Recent Pat Nanotechnol. 2010 Jun;4 (2): 100-10).

Carbon black is a frequent conductive additive to either the electrochemically active graphite in the anode, or the metal oxide in the cathode, which is added to improve the electron conductivity and thus the charge and discharge rates of lithium batteries. In fact, lithium battery composite electrodes commonly incorporate 1-10% wt. of carbon black additives in their formulation. Nevertheless, thermal carbon black presents a low crystallinity, which derives into a lower electrical conductivity, higher brittleness and a broad particle size distribution of its globular particles, which results in non-homogenous properties between batches. Moreover, carbon black can be highly reactive with organic electrolytes, particularly at voltages higher than 4.2 V (U.S. Pat. No. 9,368,798), with the consequent safety risk. In addition, Liu et al. (Liu Z et al. “Effects of conducting carbon on the electrochemical performance of LiCO₂ and LiMn₂O₄ cathodes”, J. Power Sources 2001; 97-8: 361-5) investigated the effects of carbon black on the electrochemical performance of LiCoO₂ and LiMn₂O₄ cathodes, and found that the non-performance of LiCoO₂ or LiMn₂O₄ results primarily from incomplete charging caused by deteriorating particle contacts between the oxides and carbon black.

U.S. Pat. No. 7,550,232 discloses the use of carbon nanotubes (CNT) and graphite in the anode of a lithium battery. However, U.S. Pat. No. 7,550,232 does not show improvement of charge and discharge rates and does not provide a conductive additive for the cathode of lithium batteries.

Sodium batteries present their very own challenges. For instance, since a sodium ion (1.02 Å) is 55% larger than lithium ion (0.69 Å), it is more difficult to accommodate sodium ions in anodes reversibly. In fact, graphite materials commercially used as anodes in lithium batteries could not achieve acceptable performances on sodium batteries, because graphite anodes that have been used up to now in sodium batteries absorb too little sodium. Alternative anode materials such as red phosphorus (P) have been used to overcome the limitations of graphite as an anode material. However, (1) pristine red P has a very low electrical conductivity (˜10-14 S cm−1); (2) the large volume expansion during sodiation/desodiation may cause severe capacity decay (Wang et al, “Influence of Conductive additives on the stability of red phosphorus-carbon anodes for sodium-ion batteries”. Scientific Reports 2019. 9:946). Introducing conductive additives in the synthesis of these anode materials could effectively overcome these drawbacks.

Either for sodium or for lithium batteries, there remains a need in the art to find conductive additive materials with high conductivity that could help improving the charge and discharge rate, enhancing their lifetime, lowering the internal resistance of a battery cell and retaining electrolyte of lithium or sodium batteries. More specifically, there is a need to further develop the properties of conductive additive materials in the anode and/or cathode to obtain lithium or sodium batteries with fast charge and discharge rates while having physical properties that enable a safe manufacturing and use.

### SUMMARY TO THE INVENTION

The inventors have found that carbon nanofibres-comprising carbon networks can be beneficially used to replace existing conductive additives such as carbon black currently used in lithium and sodium batteries, to the extent that the above goals in the art can be fulfilled; in particular, lifetime (stability over extended cycling) and fast charge and discharge rates, all while having physical properties that enable a safe manufacturing and use.

Advantageously, the inventors found that anodes and/or cathodes comprising the carbon nanofibres-comprising carbon networks as conductive additive according to the invention can contribute to lithium and sodium battery lifetime (stability over extended cycling) by improving electron conductivity; reference is made to FIG. 3, FIG. 5 and Table 4 herein. Because the electron conductivity of the carbon nanofibres-comprising carbon networks according to the invention is high, the reversibility of the charge/discharge process is also enhanced, reference is made to FIG. 3 and Table 4 herein. Crucially, the inventors also found that the charge and discharge rates can be improved by adding the carbon nanofibres-comprising carbon networks according to the invention as additives to the anode and/or cathode of lithium and sodium batteries; reference is made to FIG. 4 and FIG. 6 herein.

Without wishing to be tied down to any theory, the inventors believe that these advantageous properties could be attributed to the networks' inherent electron conductivity and open pore structure due to their crystallinity, accessible porosity, filaments length-to-diameter ratio and their d-spacing, which can help in the speed of intercalation of lithium or sodium ions. In addition, the inventors found that the use of the carbon nanofibres-comprising carbon networks according to the invention as additives to the anode and/or cathode of lithium or sodium batteries allows for high charge/discharge rates, thus providing for batteries with a reduced charging time. In particular, it allows the manufacturing of batteries charging in minutes instead of hours.

In a preferred embodiment, these porous carbon networks form an intraparticle porous network wherein the carbon nanofibers are interconnected to other carbon nanofibers in the network by chemical bonds via junctions, wherein the pores in the network have an intraparticle pore diameter size of 5-150 nm using Mercury Intrusion Porosimetry according to ASTM D4404-10, and the carbon nanofibers have an average aspect ratio of fibre length-to-thickness of at least 2. The porous networks are preferably characterized by a d-spacing of 0.340-0.5 nm, more preferably of 0.35-0.45 nm, even more preferably of 0.355-0.375 nm. The d-spacing is measured according to XRD. Crucially, this d-spacing is higher than that of graphite (0.335 nm), which facilitates the intercalation of lithium and sodium ions. Because of their higher volume, this higher d-spacing is particularly beneficial to the intercalation of sodium ions in sodium batteries.

The invention thus pertains to the use of carbon nanofibres-comprising carbon networks as additives to the anode and/or cathode of lithium or sodium batteries; to the anode and/or cathode comprising these carbon nanofibres-comprising carbon networks as additives; and to the lithium or sodium batteries comprising these anodes and/or cathodes. While the invention in broadest sense also relates to solid state lithium and sodium batteries, the invention preferably relates to sodium-ion or lithium-ion batteries, more preferably lithium-ion batteries.

Furthermore, the inventors have found that the carbon nanofibres-comprising carbon networks according to the invention can provide a conductive scaffold and act as a sulfur host material in the cathode of a Lithium-Sulfur (Li—S) battery. Advantageously, the networks of the invention can mitigate the “shuttle effect”. The “shuttle effect” is a process in which Li₂Sₓ are formed at the cathode of a Li—S battery and diffuse to the anode where they are reduced to polysulfides that diffuse back to the cathode. This continuous process results in a continuous leakage of active material from the cathode. The “shuttle effect” is the main reason for battery degradation and large sulfur volume expansion during discharge for Li—S batteries. The porous, chemically interconnected, carbon nanofibres-comprising carbon networks have a functionalized surface; reference is made to Table 2, wherein it is shown that the pH of the networks is slightly acidic to neutral (5.0-7.0). In other words, the surface comprises groups that alter the hydrophobic nature of the surface—which is typical for carbon—to a more hydrophilic nature. The surface of the carbon networks comprises carboxylic groups, hydroxylic groups and phenolics. These groups add some polarity to the surface and may change the properties of the compound material in which the functionalized carbon networks are embedded. Without wishing to be bound to a theory, it is believed that the networks of the invention can mitigate the “shuttle effect” thanks to their surface group functionalisation. The hydrophilic functionalisation results in polysulfides that are more strongly bound to the carbon, preventing these polysulfides to migrate to the anode. Therefore in a further aspect, the invention pertains to the use of carbon nanofibres-comprising carbon networks as additives to the cathode of Li—S batteries.

### BRIEF DESCRIPTION OF THE DRAWINGS

FIG. 1A is a schematic diagram of a continuous furnace carbon black producing process in accordance with the present invention which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying (atomizing) a single-phase emulsion c in the reaction zone 3b containing the hot waste gas, carbonizing said emulsion at increased temperature, and quenching or stopping the reaction in the termination zone 3c by spraying in water d, to obtain crystalline carbon networks e according to the invention;

FIG. 1B is a schematic diagram of a semi-batch carbon black producing process where a single-phase emulsion c is atomized through a nozzle 4 at the top of the reactor 3 into the reactor zone 3b at elevated temperatures, carbonizing said emulsion at the elevated temperature in the reactor zone 3b, and collecting the crystalline carbon networks e at the bottom of the reactor. Additionally two gas-inlets are present that enter the reactor from the top, for adding inert gas f, preferably nitrogen for controlling and/or depletion of oxygen-levels, and for introducing a carbon-containing gas g into the reactor, preferably acetylene or ethylene.

FIG. 2 depicts a schematic side sectional view of a lithium or sodium battery according to the invention, hereby exemplified as a lithium-ion or sodium-ion battery including an anode 5 and/or a cathode 6 comprising carbon nanofibres-comprising carbon networks in accordance with an embodiment of the present invention. The lithium-ion or sodium-ion battery also comprises a separator 7 between the anode and the cathode and an electrolyte 8. The release of electrons (oxidation) and of lithium or sodium ions from the anode towards the cathode takes place during the discharge cycle.

FIG. 3: Specific capacity of lithium-ion battery anodes comprising carbon nanofibres-comprising carbon networks as conductive additives according to the invention.

FIG. 4: Cyclability at different C-rates of lithium-ion battery anodes comprising carbon nanofibres-comprising carbon networks as conductive additives according to the invention. Capacity vs cycle and series of cycles at different C-rate.

FIG. 5: Specific capacity of lithium-ion battery anodes comprising carbon nanofibres-comprising carbon networks as conductive additives according to the invention.

FIG. 6.: Cyclability at different C-rates of lithium-ion battery anodes comprising carbon nanofibres-comprising carbon networks as conductive additives according to the invention. Capacity vs cycle and series of cycles at different C-rate.

### EMBODIMENTS OF THE INVENTION

1. Use of porous, chemically interconnected, carbon nanofibres-comprising carbon networks as conductive additive material in the anode and/or cathode of rechargeable lithium or sodium batteries.
2. Use according to embodiment 1, wherein said carbon-nanofibre comprising carbon networks represent 0.1-20 wt %, preferably more than 0.1 wt % and less than 20 wt %, of the total mass of the cathode, and/or wherein said carbon-nanofibre comprising carbon networks represent 0.1-10 wt %, preferably more than 0.1 wt % and less than 10 wt %, of the total mass of the anode.
3. Use according to embodiment 1 or 2, wherein the carbon networks comprise crystalline carbon-nanofibres.
4. Use according to any one of the preceding embodiments, wherein the average fibre length of the carbon-nanofibres is 30-10,000 nm.
5. Use according to any one of the preceding embodiments, wherein the carbon networks form an intraparticle porous network wherein the carbon nanofibers are interconnected to other carbon nanofibers in the network by chemical bonds via junctions, wherein the pores in the network have an intraparticle pore diameter size of 5-150 nm using Mercury Intrusion Porosimetry according to ASTM D4404-10, wherein the carbon nanofibers have an average aspect ratio of fibre length-to-thickness of at least 2, preferably having a d-spacing in the range of 0.340-0.5 nm.
6. Use according to any one of the preceding embodiments, wherein the lithium or sodium batteries are suited for smartphones, laptops, digital cameras and camcorders, medical and communication systems, as Uninterruptible Power Supply (UPS), as power plant energy storage and electric and/or hybrid vehicles.
7. A lithium or sodium battery anode and/or cathode comprising porous, chemically interconnected, carbon nanofibres-comprising carbon networks as conductive additive material, the lithium or sodium battery anode and/or cathode preferably being a lithium-ion or sodium-ion battery anode and/or cathode.
8. A lithium or sodium battery anode and/or cathode comprising porous, chemically interconnected, carbon nanofibres-comprising carbon networks, wherein said carbon-nanofibre comprising carbon networks represent 0.1-20 wt %, preferably more than 0.1 wt % and less than 20 wt %, of the total mass of the cathode, and/or wherein said carbon-nanofibre comprising carbon networks represent 0.1-10 wt %, preferably more than 0.1 wt % and less than 10 wt %, of the total mass of the anode.
9. The lithium or sodium battery anode and/or cathode according to embodiment 7 or 8, wherein the carbon networks form an intraparticle porous network wherein the carbon nanofibers are interconnected to other carbon nanofibers in the network by chemical bonds via junctions, wherein the pores in the network have an intraparticle pore diameter size of 5-150 nm using Mercury Intrusion Porosimetry according to ASTM D4404-10, and the carbon nanofibers have an average aspect ratio of fibre length-to-thickness of at least 2, preferably having a d spacing in the range of 0.340-0.5 nm.
10. The lithium or sodium battery anode and/or cathode according to any of embodiments 7-9, wherein the anode and/or the cathode also comprises 0.1-10 wt % of a binder.
11. The lithium or sodium battery anode and/or cathode according to any of embodiments 7-10, wherein the cathode and/or anode also comprises 0.1-10 wt %, preferably 0.5-5 wt %, most preferably 1-3 wt % of one or more further conductive additives selected from conductive carbon black, Super P, acetylene black, carbon nanofibers, and carbon nanotubes.
12. A rechargeable lithium or sodium battery comprising the anode and/or cathode according to any one of embodiments 7-11, the lithium or sodium battery preferably being a lithium-ion or sodium-ion battery.
13. The lithium or sodium battery according to embodiment 12, wherein said battery is comprised in and suited for smartphones, laptops, digital cameras and camcorders, medical and communication systems, as Uninterruptible Power Supply (UPS), as power plant energy storage and electric and/or hybrid vehicles.
14. Use according to any one of embodiments 1-6, the lithium or sodium battery anode and/or cathode according to any one of embodiments 7-11 or the lithium or sodium battery according to embodiment 12 or 13, wherein the carbon networks are obtainable by a process for producing crystalline carbon networks in a reactor 3 which contains a reaction zone 3b and a termination zone 3c, by injecting a water-in-oil or bicontinuous micro-emulsion c comprising metal catalyst nanoparticles, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon networks e, transferring these networks e to the termination zone 3c, and quenching or stopping the formation of crystalline carbon networks in the termination zone by spraying in water d.
15. A battery-powered device comprising the lithium or sodium battery anode and/or cathode according to any one of embodiments 7-11 or the lithium or sodium battery according to embodiment 12 or 13,the lithium or sodium battery preferably being a lithium-ion or sodium-ion battery.
16. The device according to embodiment 15, which is an smartphone, a laptop, a digital camera, a camcorder, a medical and communication system, an Uninterruptible Power Supply (UPS), a power plant energy storage device or an electric and/or hybrid vehicle.
17. The use according to any one of embodiments 1-6, wherein the lithium battery is a lithium-sulfur (Li—S) battery.
18. The lithium battery cathode according to any one of embodiments 7-11, wherein the cathode comprises a sulfur composite comprising porous, chemically interconnected, carbon nanofibres-comprising carbon networks as conductive additive material.
19. The battery anode according to any one of embodiments 8-11, wherein the battery is a lithium battery, wherein the anode comprises 90-99.9 wt. % of an additional active material, wherein the additional active material is graphite, silicon, a silicon-based compound (SiO₂) or a combination thereof.
20. The battery anode according to embodiment 19, wherein the additional active material is silicon, a silicon-based compound (SiO₂), or a combination thereof, wherein silicon, the silicon-based compound (SiO₂), or combination thereof are mixed with the carbon nanofibres-comprising carbon networks in the anode or the carbon nanofibres-comprising carbon networks are coated with silicon, the silicon-based compound (SiO₂), or combination thereof.

### DETAILED DESCRIPTION

The following is copied from Roselin (Roselin et al., “Recent Advances and Perspectives of Carbon-Based Nanostructures as Anode Materials for Li-ion Batteries”. Materials 2019, 12, 1229), explaining the working principles of batteries, exemplified by a lithium-ion (Li-ion) battery, the content of which is herewith incorporated by reference.

A battery is a device that changes chemical energy into electric energy by means of electrochemical oxidation-reduction reaction (redox) reaction. The essential electrochemical unit achieving such energy change is known as a “cell”. A battery contains a group of interconnected cells. The number of cells utilized relies upon the desired capacity and voltage for a specific application. A few electrochemical cells are associated with the arrangement as well as in parallel to acquire a lithium-ion battery of indicated voltage and capacity. Each cell contains the following parts: a negative terminal (anode), where electrochemical oxidation happens during discharge; a positive terminal (cathode), where electrochemical decrease happens; an electrolyte, which encourages the transportations of ions from one electrode to another electrode; a separator, which gives electronic segregation between the electrodes; and a casing, which contains the other cell parts. Lithium-ion cells use a solid reductant as an anode and a solid oxidant as a cathode.

The cathode materials used in most of the commercial Li-ion batteries are LiCoO₂ or LiNiO₂ and the anode materials are carbonaceous. During cell charging, the cathode material releases Li ions to the electrolyte and electrons are removed from the cathode by applying an external field and are then transferred to the anode. The charge-compensating Li ions are attracted by the negative electrode and then inserted into it. During cell discharge, the reverse reaction occurs. That is, the anode supplies intercalated Li ions into the electrolyte and provides electrons to the external circuit. At the cathode, the Li ions intercalate from the electrolyte and satisfy the charge of electrons from an external circuit. Common carbon anode materials are graphite or coke-type or both combined; common cathode materials include LiMn₂O₄, LiCoO₂, and LiNiO₂. The electrolyte can be either solid or liquid. The liquid electrolyte is usually a non-aqueous solution of Li salts and various solvents including ethers, esters, and carbonates. The cell reactions that occur at the cathode and anode during cell charging and discharging are represented as follows (Equations (1)-(4)):

$$during charging$$

$$at cathode : {LiMO}_{2} \to {Li}_{1 - x} {MO}_{2} + {x Li}^{+} + {xe}^{-} \qquad ( 1 )$$

$$at anode : x {Li}^{+} + {xe}^{-} + C \to {Li}_{x} C \qquad ( 2 )$$

$$during discharging$$

$$at cathode : {Li}_{1 - x} {MO}_{2} + {x Li}^{+} + {xe}^{-} \to {LiMO}_{2} \qquad ( 3 )$$

$$at anode : {Li}_{x} C \to {x Li}^{+} + {xe}^{-} + C \qquad ( 4 )$$

Connecting the electrodes to an external load results in an electron flow in the external circuit and the ions move through the electrolyte. The charge flows result from electrochemical (or redox) reactions at the electrodes that include chemical species and electrons and occur at various voltages. The output voltage of the battery is given by the voltage difference between the two redox reactions. In a primary battery, the redox reactions can't be turned around and the system must be discharged once, while in a secondary (or rechargeable) battery, the redox reactions are reversible, which results in multiple charging and discharging cycles. The aforementioned example of electrochemical reactions of lithium batteries extends to sodium batteries, mutatis mutandis.

The invention concerns secondary or rechargeable batteries, and particularly provides for a conductive additive to the cathode and/or the anode in the above redox reactions (1) and/or (2). In the context of the invention, a ‘lithium battery’ or ‘sodium battery’ includes both solid state (with solid electrolyte) and liquid state (with liquid electrolyte) batteries. In the context of the invention, the terms ‘lithium-ion battery’ and ‘sodium-ion battery’ are reserved for battery technology with a liquid electrolyte.

In a first aspect, the invention can be described as the use of porous, chemically interconnected, carbon nanofibres-comprising carbon networks (i.e. porous carbon networks which comprise chemically interconnected carbon-nanofibres) as a conductive additive in the electrodes of a lithium or sodium battery. The conductive additive can be applied in the cathode and/or anode, preferably in both cathode and anode. In this context, a “conductive additive” is to be understood as a material which is added to a main active material (the material which actively participates in the electrochemical charge and/or discharge reaction) in the cathode and/or anode to enhance the inherent properties of the active material such as the electron conductivity.

Related therewith, the invention pertains to a cathode and/or anode for a lithium or sodium battery comprising porous, chemically interconnected, carbon nanofibres-comprising carbon networks (i.e. porous carbon networks which comprise chemically interconnected carbon-nanofibres) as conductive additive to enhance the inherent properties of the active material. In particular, the invention pertains to a cathode and/or anode for a lithium or sodium battery comprising porous, chemically interconnected, carbon nanofibres-comprising carbon networks.

In a preferred embodiment, the cathode for a lithium or sodium battery comprises porous, chemically interconnected, carbon nanofibres-comprising carbon networks in an amount of 0.1-20 wt %, preferably more than 0.1 wt % and less than 20 wt %, more preferably 0.5-15 wt %, even more preferably 1-10 wt % of the cathode, most preferably 1.5-5 wt %, the remainder preferably being active cathode material capable of intercalation and release of lithium or sodium ions. Preferably, and in connection with the amounts of carbon networks in the preceding sentence, the active material is present in an amount of 80-99.9 wt %, more preferably 85-99.5 wt %, even more preferably 90-99 wt % of the cathode, most preferably 95.0-98.5 wt %, respectively. It is preferred that the above numbers on amounts of carbon networks and active material together make up 100% of the cathode.

In a preferred embodiment, the anode for a lithium or sodium battery comprises porous, chemically interconnected, carbon nanofibres-comprising carbon networks in an amount of 0.1-10 wt %, preferably more than 0.1 wt % and less than 10 wt %, more preferably 0.5-8 wt %, even more preferably 1-6 wt % of the anode, most preferably 1.5-5 wt %, the remainder preferably being active anode material capable of intercalation and release of lithium or sodium ions. Preferably, and in connection with the amounts of carbon networks in the preceding sentence, the active material is present in an amount of 90-99.9 wt %, more preferably 92-99.5 wt %, even more preferably 94-99 wt % of the anode, most preferably 95.0-98.5 wt %, respectively. It is preferred that the above numbers on amounts of carbon networks and active material together make up 100% of the anode.

For lithium batteries, preferably the active material in the anode is an intercalation compound such as graphite, a metal alloy such as tin, silicon based metal alloys and/or a conversion compound such as transition-metal oxides (MO, where M is Sn, Mo, Ga, Zn, Si, Ge, Co, Ni, Cu or Fe). In a preferred embodiment, the active material in the anode is graphite. For lithium batteries, preferably the additional active material in the anode is an intercalation compound such as graphite, a metal alloy such as tin, silicon based metal alloys, silicon or silicon-based compounds such as SiO₂, and/or a conversion compound such as transition-metal oxides (MO, where M is Sn, Mo, Ga, Zn, Si, Ge, Co, Ni, Cu or Fe). In a preferred embodiment, the additional active material in the anode of lithium batteries is graphite, silicon, a silicon-based compound (SiO₂) or a combination thereof. In another preferred embodiment, the additional active material in the anode of lithium batteries is silicon, a silicon-based compound (SiO₂) or a combination thereof. Most preferably, the additional active material is silicon or graphite. If the additional active material in the anode is silicon, a silicon-based compound (SiO₂), or a combination thereof, silicon, the silicon-based compound (SiO₂), or combination thereof are mixed with the carbon nanofibres-comprising carbon networks of the invention in the anode or the carbon nanofibres-comprising carbon networks of the invention are coated with silicon, a silicon-based compound (SiO₂), or combination thereof. For lithium batteries, preferably the active material in the cathode is a lithium or sodium metal, alkali metal and/or lithium or sodium metal oxide. In a preferred embodiment, the active material in the cathode is LiCoO₂ or LiMn₂O₄ for lithium cathodes. In another preferred embodiment, the active material in the cathode is lithium iron phosphate (LiFePO₄). In a further preferred embodiment, the active material in the cathode comprises sulfur, a sulfur compound, or a sulfur composite.

For sodium batteries, preferably the active material in the anode is an oxide for intercalation-type anodes such as TiO₂, oxide for conversion-type anode such as Fe₂O₃, oxide for conversion-alloying-type anode such as SnₓO₂ and Sb₂O₃ or “hard carbon”, a disordered carbon material consisting of a non-graphitizable, non-crystalline and amorphous carbon structure. For sodium batteries, preferably the active material in the cathode is an O3-type layered metal oxide such as NaFeO₂, P2-type layered metal oxide such as Na_{0.6}MnO₂, biphase layered metal oxide such as Na_{0.78}Ni_{0.2}Fe_{0.38}Mn_{0.42}O₂ or an oxide with anionic redox capability. Preferably, the active material in the cathode of sodium batteries is a sodium oxide (NaMO₂, M=V, Fe, Mn, Cu, Co., and Ni), sodium phosphate (Na₇V₃(P₂O₇)₄, NaFePO₄, transition metal oxide (V₂O₅) or Prussian blue (PB, Na₂M[Fe(CN)₆]).

The anode and/or the cathode of both lithium and sodium batteries may also comprise 0.1-10 wt %, preferably 2-8 wt %, most preferably 4-6 wt % of a binder. Preferably, the binder is selected from Styrene-Butadiene Rubber (SBR) based and Polyvinylidene Fluoride (PVDF) based binders. Preferably the binder is PVDF (polyvinylidene difluoride).

Among the advantageous effects of the use of the carbon networks according to the invention as conductive additive in the electrodes of a lithium or sodium battery is a higher electroconductivity. In addition, the carbon networks admit a high level of Fe and/or other metals without causing issues, which enhances the industrial applicability and safety of the electrodes. The carbon network according to the invention comprises a larger distance interlayer compared with carbon black; this enables to keep the viscosity reduced, even when adding even higher amounts of additive material when compared to carbon black. While the use of conventional conductive additives is associated with viscosity increase hampering both processing and maximum loading, the carbon networks of the invention can be added with increased numbers without affecting viscosity disadvantageously.

The invention also relates to a secondary or rechargeable lithium or sodium battery comprising the above-cited cathode and/or anode. Preferably, the secondary or rechargeable battery is a secondary or rechargeable lithium-ion or sodium-ion battery, most preferably a lithium-ion battery. In a further preferred embodiment, the secondary or rechargeable battery is a Li—S battery.

In addition to the aforementioned anode and cathode, the secondary or rechargeable lithium or sodium battery also comprises an electrolyte, which may be liquid or solid-state. The liquid electrolyte may comprise an organic solvent and a salt of an alkali metal, preferably a lithium or sodium salt for lithium-ion and sodium-ion batteries, respectively. The electrolyte of the lithium or sodium batteries may also be solid-state and comprise inorganic-ceramic/glass-ceramic, organic polymer and/or ceramic-polymer composite electrolytes. The secondary or rechargeable lithium or sodium battery may also comprise a separator between the anode and the cathode. The separator may comprise a polymer such as polypropylene.

The cathode and/or anode for lithium or sodium batteries or lithium or sodium batteries of the invention are particularly suitable for use in the manufacture of battery-powered electric devices. Hence the invention extends to battery-powered electric devices comprising at least one cathode and/or anode for lithium or sodium batteries or at least one lithium or sodium battery comprising the porous, chemically interconnected, carbon-nanofibre comprising carbon networks according to the invention. Here a battery-powered electric device may be a smartphone, laptop, digital cameras and camcorders, medical and communication systems, as Uninterruptible Power Supply (UPS), as power plant energy storage (i.e. from surplus wind and solar renewable energy) and electric and/or hybrid vehicles. Preferably, the anode for lithium or sodium batteries or lithium or sodium batteries according to the invention are used in Uninterruptible Power Supply (UPS) systems, portable consumer electronics and electric and/or hybrid vehicles.

While it is particularly advantageous to use the networks according to the invention as the sole conductive additive, the cathode and/or anode for a lithium or sodium battery according to the invention may comprise further conventional additives (non-active materials) on top of the additive comprising the porous, chemically interconnected, carbon nanofibres-comprising carbon networks, in order to further improve the electrochemical performance of the lithium or sodium batteries according to the invention. It is considered within the skilled person ambit to select suitable conductive additives available in the art. In a preferred embodiment, the cathode and/or anode for lithium or sodium batteries or lithium or sodium batteries according to the invention may contain 0.1-10 wt %, preferably 0.5-5 wt %, most preferably 1-3 wt % of one or more further conductive additives selected from conductive carbon black, Super P, acetylene black, carbon nanofibers, and carbon nanotubes. In a preferred embodiment, the further conductive additive is carbon black.

### Carbon Nanofibre-Comprising Carbon Networks

The porous, chemically interconnected carbon nanofibre-comprising carbon networks or porous carbon networks comprising chemically interconnected carbon nanofibers are preferably characterized as follows:

The skilled person will understand that a porous network refers to a 3-dimensional structure that allows fluids or gasses to pass through. A porous network may also be denoted as a porous medium or a porous material. A porous crystalline carbon network according to the invention (or a porous carbon network particle of the invention) can be seen as a big molecule, wherein the carbon atoms inherently are covalently interconnected. It is hereby understood that a porous carbon network particle is a particle with chemically interconnected (i.e. covalently bonded) fibres having intraparticle porosity, as opposed to interparticle porosity which refers to a porous network created by multiple molecules or particles and wherein the pores are formed by the space between physically aggregated particles or molecules. In the context of the current invention, intraparticle porosity may also be denoted as intramolecular porosity as the carbon network particle according to the invention can be seen as a big molecule, wherein the pores are embedded. Hence intraparticle porosity and intramolecular porosity have the same meaning in the current text and may be used interchangeably.

As the networks of the invention can be seen as one big molecule, there is no need to fuse particles or parts of the network together. Hence it is preferred that the porous, chemically interconnected, carbon-nanofibrecomprising carbon networks are non-fused, intraparticle porous, chemically interconnected, crystalline carbon nanofibres-comprising carbon networks, having intraparticle porosity. Without being bound to a theory, it is believed that the benefit of having a crystalline network with intraparticle porosity over a(n amorphous) network with interparticle porosity is that the first are more robust and more resilient against crushing and breaking when force is applied. For comparison sake, carbon black consists of aggregates or agglomerates of spherical particles that may form a 3-dimensional structure, where spheres are fused with amorphous connections with weaker porosity. The interparticle pores are weaker due to the particle-particle interface and tend to collapse. Intraparticle pores are strong due to the covalently crystalline aligned bonded structure surrounding them and can withstand high forces and pressures without collapsing. This is sharp contrast with conventional carbon black, consisting of aggregates or agglomerates of spherical particles that may form a 3-dimensional structure, where spheres are fused with amorphous connection between the individual particles (not chemically ‘interconnected’). Summarizing, intraparticle porosity (a trademark for the networks of the invention) refers to the situation wherein the carbon atoms surrounding the pores are covalently connected in crystalline form, wherein interparticle porosity refers to pores residing between particles which are physically aggregated, agglomerated, or have amorphous connections. Intraparticle pore volume may be characterized in terms of Mercury Intrusion Porosimetry (ASTM D4404-10) or Nitrogen Absorption method (ISO 9277:10). The pore volume of the porous carbon networks according to the invention is 0.05-5 cm³/g, preferably 0.1-4 cm³/g, more preferably 0.3-3.5 cm³/g and most preferably 0.5-3 cm³/g as measured using Mercury Intrusion Porosimetry (ASTM D4404-10). Additionally or alternatively, the carbon nanofibres-comprising carbon networks may be characterized having an intraparticle pore diameter size as measured using Mercury Intrusion Porosimetry (ASTM D4404-10) of 5-200 nm, preferably 10-150 nm, and most preferably of 20-130 nm. Following the same ASTM test method, the networks may have an interparticle pore diameter of 10-500 μm, more preferably 80-400 μm.

The porous networks are preferably characterized by a d-spacing in the range of 0.340-0.50 nm, more preferably in the range of 0.35-0.45 nm, even more preferably in the range of 0.355-0.375 nm. The d-spacing is measured according to XRD.

The skilled person will readily understand that the term chemically interconnected in porous, chemically interconnected, carbon nanofibres-comprising carbon networks implies that the carbon-nanofibres are interconnected to other carbon-nanofibres by chemical bonds. It is also understood that a chemical bond is a synonym for a molecular or a covalent bond. Typically those places where the carbon-nanofibres are connected are denoted as junctions or junctions of fibres, which may thus be conveniently addressed as ‘covalent junctions’ These terms are used interchangeable in this text. In the carbon networks according to the invention, the junctions are formed by covalently connected carbon atoms. It furthermore follows that the length of a fibre is defined as the distance between junctions which are connected by fibrous carbon material.

In a preferred embodiment, at least part of the fibres in the carbon nanofibres-comprising carbon networks of the invention are crystalline carbon-nanofibres. Preferably at least 20 wt. % of the carbon in the carbon networks in the invention is crystalline, more preferably at least 40 wt. %, even more preferably at least 60 wt. %, even more preferably at least 80 wt. % and most preferably at least 90 wt. %. Alternatively the amount of crystalline carbon is 20-90 wt. %, more preferably 30-70 wt. %, and more preferably 40-50 wt. % compared to the total carbon in the carbon networks of the invention. Here ‘crystalline’ has its usual meaning and refers to a degree of structural order in a material. In other words the carbon atoms in the nanofibres are to some extent arranged in a regular, periodic manner. The areas or volumes which are crystalline can be denoted as crystallites. A carbon crystallite is hence an individual carbon crystal.

A measure for the size of the carbon crystallites is the stacking height of graphitic layers. Standard ASTM grades of carbon black have a stacking height of the graphitic layers within these crystallites ranging from 11-13 Å (angstroms). In a preferred embodiment, the carbon nanofibres-comprising carbon networks of the invention preferably have a stacking height of at least 15 Å (angstroms), preferably at least 16 Å, more preferably at least 17 Å, even more preferably at least 18 Å, even more preferably at least 19 Å and still more preferably at least 20 Å. If needed the carbon networks with crystallites as large as 100 Å (angstroms) can be produced. Hence the carbon networks of the invention have a stacking height of 15-100 Å (angstroms), more preferably of up to 80 Å, even more preferably of up to 60 Å, even more preferably of up to 40 Å, still more preferably of up to 30 Å. It is therefore understood that the stacking height of graphitic layers within crystallites in the carbon networks of the invention is 15-90 Å (angstroms), more preferably 16-70 Å, even more preferably 17-50 Å, still more preferably 18-30 Å and most preferably up to 25 Å.

The porous, chemically interconnected, carbon nanofibres-comprising carbon networks may be defined as having chemically interconnected carbon-nanofibres, wherein carbon-nanofibres are interconnected via junction parts, wherein several (typically 3 or more, preferably at least 10 or more) nanofibres are covalently joined. Said carbon-nanofibres are those parts of the network between junctions. The fibres typically are elongated bodies which are solid (i.e. non-hollow), preferably having an average diameter or thickness of 1-500 nm, preferably of 5-350 nm, more preferably up to 100 nm, in one embodiment 10-100 nm, compared to the average particle size of 10-400 nm for carbon black particles. In one embodiment, the average fibre length (i.e. the average distance between two junctions) is preferably in the range of 30-10,000 nm, more preferably 50-5,000 nm, more preferably 100-5,000 nm, more preferably at least 200-5,000 nm, as for instance can be determined using SEM.

The nanofibres or structures may preferably be described in terms of an average aspect ratio of fibre length-to-thickness of at least 2, preferably at least 3, more preferably at least 4, and most preferably at least 5, preferably at most below 50; in sharp contrast with the amorphous (physically associated) aggregates formed from spherical particles obtained through conventional carbon black manufacturing. The average aspect ratio of fibre length-to-thickness can be determined for instance using SEM.

The carbon-nanofibre structures may be defined as carbon networks formed by chemically interconnected (covalently bonded) carbon-nanofibres. Said carbon networks have a 3-dimensional configuration wherein there is an opening between the carbon-nanofibres (the intraparticle porosity, see above) that is accessible to a continuous phase, which may be a liquid—such as a solvent or an aqueous phase—, a gas or any other phase. Said carbon networks are at least 0.5 μm in diameter, preferably at least 1 μm in diameter, preferably at least 5 μm in diameter, more preferably at least 10 μm in diameter, even more preferably at least 20 μm in diameter and most preferably at least 25 μm in all dimensions. Alternatively said carbon networks are at least 1 μm in diameter in 2 dimensions and at least 5 μm in diameter, preferably at least 10 μm in diameter, more preferably a least 20 μm in diameter and most preferably at least 25 μm in diameter in the other dimension. Here, and also throughout this text, the term dimension is used in its normal manner and refers to a spatial dimension. There are 3 spatial dimensions which are orthogonal to each other and which define space in its normal physical meaning. It is furthermore possible that said carbon networks are at least 10 μm in diameter in 2 dimensions and at least 15 μm in diameter, preferably at least 20 μm in diameter, more preferably a least 25 μm in diameter, more preferably at least 30 μm in diameter and most preferably at least 50 μm in diameter in the other dimension. These measurements are based on laser diffraction.

The carbon nanofibres-comprising carbon networks may have a volume-based aggregate size as measured using laser diffraction (ISO 13320-1) or dynamic light scattering analysis of 0.1-100 μm, preferably 1-50 μm, more preferably 1-40 μm, more preferably of 5-35 μm, more preferably of 5-25 μm and most preferably of 5-20 μm. In a most preferred embodiment, the networks have a volume-based aggregate size as measured using laser diffraction (ISO 13320-1) or dynamic light scattering analysis of 5-10 μm. The networks preferably have an advantageously narrow particle size distribution, particularly compared to traditional carbon black. The particle size distribution may be characterized between 10 and 200 nm, preferably 10-100 nm as determined using the transmission electronic microscope and measuring the diameter of the fibres. The networks may be characterized by an aggregate strength between 0.5 and 1, more preferably between 0.6 and 1, as determined by the c-OAN/OAN ratio measured according to ASTM D3493-16/ASTM D2414-16 respectively. The c-OAN is preferably 20-200 cc/100 g. This is an advantageously high strength which prevents collapse of the intraporosity even in high-pressure applications.

The porous, chemically interconnected, carbon nanofibres-comprising carbon networks may also comprise carbon black particles built in as part of the network. These particles are profoundly found at the junctions between carbon-nanofibres, but there may also be carbon black particles present at other parts of the network. The carbon black particles preferably have a diameter of at least 0.5 times the diameter of the carbon-nanofibres, more preferably at least the same diameter of the carbon-nanofibres, even more preferably at least 2 times the diameter of the carbon-nanofibres, even more preferably at least 3 times the diameter of the carbon-nanofibres, still more preferably at least 4 times the diameter of the carbon-nanofibres and most preferably at least 5 times the diameter of the carbon-nanofibres. It is preferred that the diameter of the carbon black particles is at most 10 times the diameter of the carbon-nanofibres. Such mixed networks are denoted as hybrid networks.

The porous, chemically interconnected, carbon nanofibres-comprising carbon networks have a functionalized surface. In other words, the surface comprises groups that alter the hydrophobic nature of the surface—which is typical for carbon—to a more hydrophilic nature. The surface of the carbon networks comprises carboxylic groups, hydroxylic groups and phenolics. These groups add some polarity to the surface and may change the properties of the compound material in which the functionalized carbon networks are embedded. The surface area of the carbon nanofibres-comprising carbon networks as measured according to the Brunauer, Emmett and Teller (BET) method (ISO 9277:10) is preferably in the range of 15-300 m²/g, more preferably 20-270 m²/g, even more preferably 30-250 m²/g and most preferably 30-210 m²/g.

The porous, chemically interconnected, carbon nanofibres-comprising carbon networks comprise metal catalyst nanoparticles, but only in minute amounts, typically at least 10 ppm based on the weight of the carbon nanofibres-comprising carbon networks. These are a fingerprint of the preparation method. There is preferred an amount of at most 5000 ppm, more preferably at most 3000 ppm, especially at most 2000 ppm of metal nanoparticles based on the weight of the networks measured by ICP-OES (Inductive Coupled Plasma-Optical Emission Spectrometry). These metal particles are also embedded in the networks. These particles may have an average particle size between 1 nm and 100 nm. Preferably said particles are monodisperse particles having deviations from their average particle size which are within 10%, more preferably within 5%. Non-limiting examples of nanoparticles included in the carbon nanofibres-comprising carbon networks are the noble metals (Pt, Pd, Au, Ag), iron-family elements (Fe, Co and Ni), Ru, and Cu. Suitable metal complexes may be (i) platinum precursors such as H₂PtCl₆; H₂PtCl₆.xH₂O; K₂PtCl₄; K₂PtCl₄.xH₂O; Pt(NH₃)₄(NO₃)₂; Pt(C₅H₇O₂)₂, (ii) ruthenium precursors such as Ru(NO)(NO₃)₃; Ru(dip)₃Cl₂ [dip=4,7-diphenyl-1,10-fenanthroline]; RuCl₃, or (iii) palladium precursors such as Pd(NO₃)₂, or (iv) nickel precursors such as NiCl₂ or NiCl₂.xH₂O; Ni(NO₃)₂; Ni(NO₃)₂.xH₂O; Ni(CH₃COO)₂; Ni(CH₃COO)₂.xH₂O; Ni(AOT)₂ [AOT=bis(2-ethylhexyl)sulphosuccinate], wherein x may be any integer chosen from 1, 2, 3, 4, 5, 6, 7, 8, 9 or 10 and typically may be 6, 7 or 8.

The porous, chemically interconnected, carbon nanofibres-comprising carbon networks are preferably obtainable by the process for the production of crystalline carbon networks in a reactor 3 which contains a reaction zone 3b and a termination zone 3c, by injecting a thermodynamically stable micro-emulsions of the water-in-oil, oil-in-water or bicontinuous type c, preferably a water-in-oil or bicontinuous micro-emulsion c, a bicontinuous micro-emulsion c, said micro-emulsion comprising metal catalyst nanoparticles, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon networks e, transferring these networks e to the termination zone 3c, and quenching or stopping the formation of crystalline carbon networks in the termination zone by spraying in water d.

In a more preferred embodiment, the networks are obtainable by the above process, said reactor being a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying a micro-emulsion of the water-in-oil, oil-in-water or bicontinuous type c, preferably a water-in-oil or bicontinuous micro-emulsion c, most preferably a bicontinuous micro-emulsion c, said micro-emulsion comprising metal catalyst nanoparticles, in the reaction zone 3b containing the hot waste gas, carbonizing said emulsion at a temperature of above 600° C., preferably above 700° C., more preferably above 900° C., even more preferably above 1000° C., more preferably above 1100° C., preferably up to 3000° C., more preferably up to 2500° C., most preferably up to 2000° C., and quenching or stopping the reaction in the termination zone 3c by spraying in water d, to yield crystalline carbon networks e.

In the above, ‘chemically interconnected’ is understood to mean that the nanofibres are covalently bonded to one another, clearly distinct from physical aggregates.

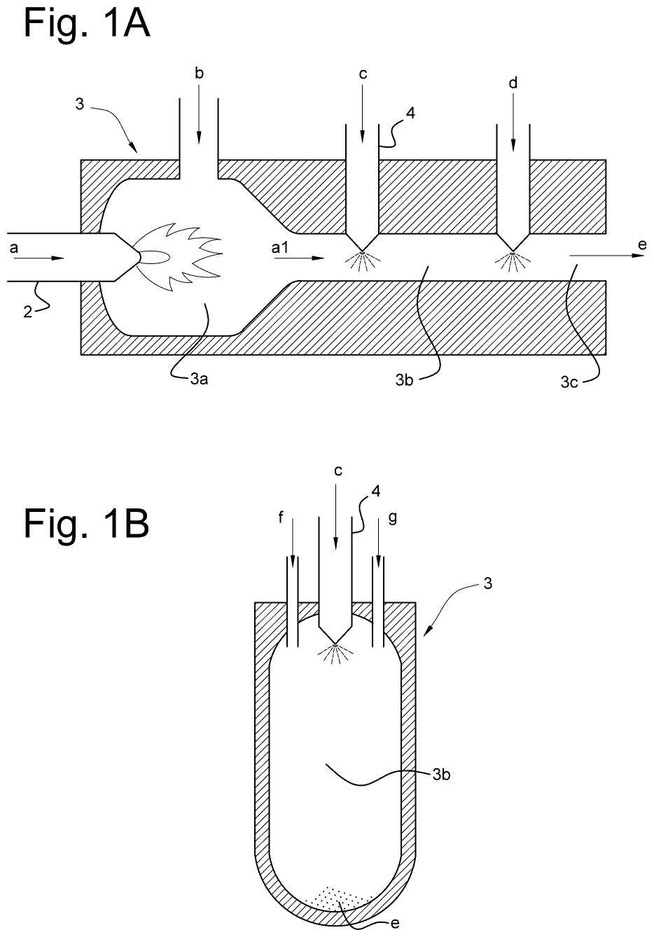

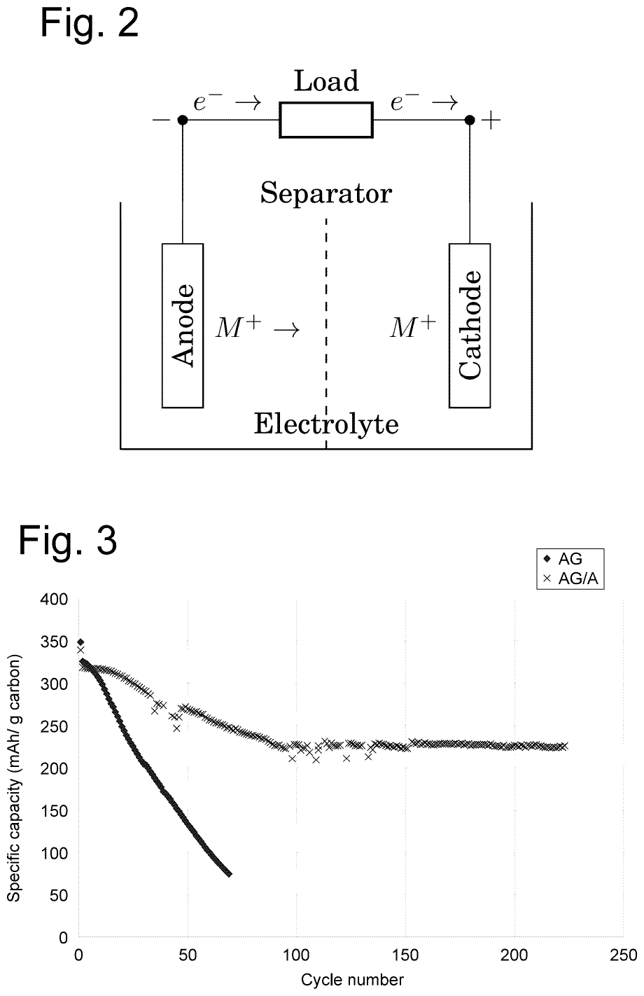

The networks are preferably obtainable by the above process wherein further processing details are provided in the section headed “Process for obtaining carbon nanofibres-comprising carbon networks” here below, and in FIG. 1A.

### Process for Obtaining Carbon Nanofibres-Comprising Carbon Networks

A process for obtaining the above-described porous, chemically interconnected, carbon nanofibres-comprising carbon networks can be described best as a modified carbon black manufacturing process, wherein ‘modified’ is understood that a suitable oil, preferably an oil comprising at least 14 C atoms (>C14) such as carbon black feedstock oil (CBFS), is provided to the reaction zone of a carbon black reactor as part of a single-phase emulsion, being a thermodynamically stable micro-emulsion of the water-in-oil, oil-in-water or bicontinuous type, preferably a water-in-oil or bicontinuous micro-emulsion, most preferably a bicontinuous micro-emulsion, comprising metal catalyst nanoparticles. The emulsion is preferably provided to the reaction zone by spraying, thus atomizing the emulsion to droplets. While the process can be carried out batch or semi-batch wise, the modified carbon black manufacturing process is advantageously carried out as a continuous process. The single-phase emulsion is a micro-emulsion comprising metal catalyst nanoparticles. The preferred single-phase emulsion comprises CBFS oil, and may be referred to as ‘emulsified CBFS’ in the context of the invention.

The process for the production of the carbon networks can be performed in a reactor 3 which contains a reaction zone 3b and a termination zone 3c, by injecting a single-phase emulsion c, being a micro-emulsion of the water-in-oil, oil-in-water or bicontinuous type c, preferably a water-in-oil or bicontinuous micro-emulsion c, most preferably a bicontinuous micro-emulsion c, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce porous, chemically interconnected, carbon nanofibres-comprising carbon networks, transferring these networks to the termination zone 3c, and quenching or stopping the formation of porous, chemically interconnected, carbon nanofibres-comprising carbon networks in the termination zone by spraying in water d. The single-phase emulsion is preferably sprayed into the reaction zone. Reference is made to FIG. 1A.

Alternatively the process for the production of the porous, chemically interconnected, carbon nanofibres-comprising carbon networks is performed in a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying (atomizing) a single-phase emulsion c according to the invention, preferably a micro-emulsion of the water-in-oil, oil-in-water or bicontinuous type c, preferably a water-in-oil or bicontinuous micro-emulsion c, most preferably a bicontinuous micro-emulsion c, in the reaction zone 3b containing the hot waste gas, carbonizing said emulsion at increased temperatures (at a temperature of above 600° C., preferably above 700°° C., more preferably above 900° C., even more preferably above 1000° C., more preferably above 1100° C., preferably up to 3000° C., more preferably up to 2500° C., most preferably up to 2000° C.), and quenching or stopping the reaction (i.e. the formation of porous, chemically interconnected, carbon nanofibres-comprising carbon networks) in the termination zone 3c by spraying in water d. The reaction zone 3b comprises at least one inlet (preferably a nozzle) for introducing the emulsion, preferably by atomization. Reference is made to FIG. 1A.

Residence times for the emulsion in the reaction zone of the furnace carbon black reactor can be relatively short, preferably ranging from 1-1000 ms, more preferably 10-100 ms. Longer residence times may have an effect on the properties of the carbon networks. An example may be the size of crystallites which is higher when longer residence times are used.

In accordance with conventional carbon black manufacturing processes, the oil phase can be aromatic and/or aliphatic, preferably comprising at least 50 wt. % C14 or higher, more preferably at least 70 wt. % C14 or higher (based on the total weight of the oil). List of typical oils which can be used, but not limited to obtain stable emulsions are carbon black feedstock oils (CBFS), phenolic oil, anthracene oils, (short-medium-long chain) fatty acids, fatty acids esters and paraffins. The oil is preferably a C14 or higher. In one embodiment, the oil preferably has high aromaticity. Within the field, the aromaticity is preferably characterized in terms of the Bureau of Mines Correlation Index (BMCI). The oil preferably has a BMCI>50. In one embodiment, the oil is low in aromaticity, preferably having a BMCI<15.

CBFS is an economically attractive oil source in the context of the invention, and is preferably a heavy hydrocarbon mix comprising predominantly C14 to C50, the sum of C14-C50 preferably amounting to at least 50 wt. %, more preferably at least 70 wt. % of the feedstock. Some of the most important feedstocks used for producing carbon black include clarified slurry oil (CSO) obtained from fluid catalytic cracking of gas oils, ethylene cracker residue from naphtha steam cracking and coal tar oils. The presence of paraffins (<C15) substantially reduces their suitability, and a higher aromaticity is preferred. The concentration of aromatics determines the rate at which carbon nuclei are formed. The carbon black feedstock preferably has a high BMCI to be able to offer a high yield with minimum heat input hence reducing the cost of manufacturing. In a preferred embodiment, and in accordance with current CBFS specifications, the oil, including mixtures of oil, has a BMCI value of more than 120. While the skilled person has no difficulties understanding which are suitable CBFS, merely as a guide it is noted that—from a yield perspective—a BMCI value for CBFS is preferably more than 120, even more preferably more than 132. The amount of asphaltene in the oil is preferably lower than 10 wt. %, preferably lower than 5.0 wt. % of the CBFS weight. The CBFS preferably has low sulphur content, as sulphur adversely affects the product quality, leads to lower yield and corrodes the equipment.

It is preferred that the sulphur content of the oil according to ASTM D1619 is less than 8.0 wt. %, preferably below 4.0 wt. % more preferably less than 2.0 wt. %.

The emulsion, preferably a CBFS-comprising emulsion, is a “single-phase emulsion” which is understood to mean that the oil phase and the water phase optically appear as one miscible mixture showing no physical separation of oil, water or surfactant to the naked eye. The single-phase emulsion is a micro-emulsion of the water-in-oil, oil-in-water or bicontinuous type, preferably a water-in-oil or bicontinuous micro-emulsion, most preferably a bicontinuous micro-emulsion. The process by which an emulsion completely breaks (coalescence), i.e. the system separates into bulk oil and water phases, is generally considered to be controlled by four different droplet loss mechanisms, i.e., Brownian flocculation, creaming, sedimentation flocculation and disproportionation.

Provided that a micro-emulsion as described above is obtained, the amounts of water and oil are not regarded limiting, but it is noted that reduced amounts of water (and increased amounts of oil) improve yields. The water content is typically between 5 and 50 wt % of the emulsion, preferably 10-40 wt %, even more preferably up to 30 wt %, more preferably 10-20 wt % of the emulsion. While higher amounts of water can be considered, it will be at the cost of yield. Without wishing to be bound by any theory, the inventors believe that the water phase attributes to the shape and morphology of the networks thus obtained.

The choice of surfactant(s) is not regarded a limiting factor, provided that the combination of the oil, water and surfactant(s) results in a stable micro-emulsion as defined here above. As further guidance to the skilled person, it is noted that the surfactant can be selected on the basis of the hydrophobicity or hydrophilicity of the system, i.e. the hydrophilic-lipophilic balance (HLB). The HLB of a surfactant is a measure of the degree to which it is hydrophilic or lipophilic, determined by calculating values for the different regions of the molecule, according to the Griffin or Davies method. The appropriate HLB value depends on the type of oil and the amount of oil and water in the emulsion, and can be readily determined by the skilled person on the basis of the requirements of retaining a thermodynamically stable, single phase emulsion as defined above. It is found that an emulsion comprising more than 50 wt % oil, preferably having less than 30 wt % water phase, would be stabilized best with a surfactant having an HLB value above 7, preferably above 8, more preferably above 9, most preferably above 10. On the other hand, an emulsion with at most 50 wt % oil would be stabilized best with a surfactant having an HLB value below 12, preferably below 11, more preferably below 10, most preferably below 9, particularly below 8. The surfactant is preferably selected to be compatible with the oil phase. In case the oil is a CBFS-comprising emulsion with a CBFS, a surfactant with high aromaticity is preferred, while an oil with low BMCI, such as characterized by BMCI<15, would be stabilized best using aliphatic surfactants. The surfactant(s) can be cationic, anionic or non-ionic, or a mixture thereof. One or more non-ionic surfactants are preferred, in order to increase the yields since no residual ions will be left in the final product. In order to obtain a clean tail gas stream, the surfactant structure is preferably low in sulfur and nitrogen, preferably free from sulfur and nitrogen. Non-limiting examples of typical non-ionic surfactants which can be used to obtain stables emulsions are commercially available series of Tween, Span, Hypermer, Pluronic, Emulan, Neodol, Triton X and Tergitol.

In the context of the invention, a micro-emulsion is a dispersion made of water, oil (preferably CBFS), and surfactant(s) that is a single optically and thermodynamically stable liquid with dispersed domain diameter varying approximately from 1 to 500 nm, preferably 1 to 100 nm, usually 10 to 50 nm. In a micro-emulsion the domains of the dispersed phase are either globular (i.e. droplets) or interconnected (to give a bicontinuous micro-emulsion). In a preferred embodiment, the surfactant tails form a continuous network in the oil-phase of a micro-emulsion of the water-in-oil, oil-in-water or bicontinuous type, preferably a water-in-oil or bicontinuous micro-emulsion, most preferably a bicontinuous micro-emulsion. The water domains should contain a metal catalyst, preferably having an average particle size between 1 nm and 100 nm.

The single-phase emulsion, i.e. a micro-emulsion of the water-in-oil, oil-in-water or bicontinuous type, preferably a water-in-oil or bicontinuous micro-emulsion, most preferably a bicontinuous micro-emulsion, further comprises metal catalyst nanoparticles preferably having an average particle size between 1 and 100 nm. The skilled person will find ample guidance in the field of carbon nanotubes (CNTs) to produce and use these kinds of nanoparticles. These metal nanoparticles are found to improve network formation in terms of both rates and yields, and reproducibility. Methods for manufacturing suitable metal nanoparticles are found in Vinciguerra et al. “Growth mechanisms in chemical vapour deposited carbon nanotubes” Nanotechnology (2003) 14, 655; Perez-Cabero et al. “Growing mechanism of CNTs: a kinetic approach” J. Catal. (2004) 224, 197-205; Gavillet et al. “Microscopic mechanisms for the catalyst assisted growth of single-wall carbon nanotubes” Carbon. (2002) 40, 1649-1663 and Amelinckx et al. “A formation mechanism for catalytically grown helix-shaped graphite nanotubes” Science (1994) 265, 635-639, their contents about manufacturing metal nanoparticles herein incorporated by reference.

The metal catalyst nanoparticles are used in a micro-emulsion of the water-in-oil, oil-in-water or bicontinuous type, preferably a water-in-oil or bicontinuous micro-emulsion, most preferably a bicontinuous micro-emulsion. Advantageously, the uniformity of the metal particles is controlled in said (bicontinuous) micro-emulsion by mixing a first (bicontinuous) micro-emulsion in which the aqueous phase contains a metal complex salt capable of being reduced to the ultimate metal particles, and a second (bicontinuous) micro-emulsion in which the aqueous phase contains a reductor capable of reducing said metal complex salt; upon mixing the metal complex is reduced, thus forming metal particles. The controlled (bicontinuous) emulsion environment stabilizes the particles against sintering or Ostwald ripening. Size, concentrations and durability of the catalyst particles are readily controlled. It is considered routine experimentation to tune the average metal particle size within the above range, for instance by amending the molar ratio of metal precursor vs. the reducing agent. An increase in the relative amount of reducing agent yields smaller particles. The metal particles thus obtained are monodisperse, deviations from the average particle size are preferably within 10%, more preferably within 5%. Also, the present technology provides no restraint on the actual metal precursor, provided it can be reduced. Non-limiting examples of nanoparticles included in the carbon nanofibres-comprising carbon networks are the noble metals (Pt, Pd, Au, Ag), iron-family elements (Fe, Co and Ni), Ru, and Cu. Suitable metal complexes may be (i) platinum precursors such as H₂PtCl₆; H₂PtCl₆.xH₂O; K₂PtCl₄; K₂PtCl₄.xH₂O; Pt(NH₃)₄(NO₃)₂; Pt(C₅H₇O₂)₂, (ii) ruthenium precursors such as Ru(NO)(NO₃)₃; Ru(dip)₃Cl₂ [dip=4,7-diphenyl-1,10-fenanthroline]; RuCl₃, or (iii) palladium precursors such as Pd(NO₃)₂, or (iv) nickel precursors such as NiCl₂ or NiCl₂.xH₂O; Ni(NO₃)₂; Ni(NO₃)₂.xH₂O; Ni(CH₃COO)₂; Ni(CH₃COO)₂.xH₂O; Ni(AOT)₂ [AOT=bis(2-ethylhexyl)sulphosuccinate], wherein x may be any integer chosen from 1, 2, 3, 4, 5, 6, 7, 8, 9 or 10 and typically is 6, 7 or 8. Non-limiting suitable reducing agents are hydrogen gas, sodium boron hydride, sodium bisulphate, hydrazine or hydrazine hydrate, ethylene glycol, methanol and ethanol. Also suited are citric acid and dodecylamine. The type of metal precursor is not an essential part of the invention. The metal of the particles of the (bicontinuous) micro-emulsion are preferably selected from the group consisting of Pt, Pd, Au, Ag, Fe, Co, Ni, Ru and Cu, and mixtures thereof, in order to control morphology of the carbon structures networks ultimately formed. The metal nanoparticles end up embedded inside these structures where the metal particles are physically attached to the structures. While there is no minimum concentration of metal particles at which these networks are formed—in fact networks are formed using the modified carbon black manufacturing process according to the invention—it was found that the yields increase with the metal particle concentrations. In a preferred embodiment, the active metal concentration is at least 1 mM, preferably at least 5 mM, preferably at least 10 mM, more preferably at least 15 mM, more preferably at least 20 mM, particularly at least 25 mM, most preferably up to 3500 mM, preferably up to 3000 mM. In one embodiment, the metal nanoparticles comprise up to 250 mM. These are concentrations of the catalyst relative to the amount of the aqueous phase of the (bicontinuous) micro-emulsion.

Atomization of the single-phase emulsion, preferably a CBFS-comprising emulsion, is preferably realized by spraying, using a nozzle-system 4, which allows the emulsion droplets to come in contact with the hot waste gas a1 in the reaction zone 3b, resulting in traditional carbonization, network formation and subsequent agglomeration, to produce carbon networks according to the invention. The injection step preferably involves increased temperatures above 600° C., preferably between 700 and 3000° C., more preferably between 900 and 2500° C., more preferably between 1100 and 2000° C.

### EXAMPLES

### Example 1: Characterization of Lithium-Ion Battery Cathodes and/or Anodes Comprising Carbon Nanofibres-Comprising Carbon Networks as Conductive Additives According to the Invention

The performance of lithium-ion batteries comprising cathodes and/or anodes comprising carbon nanofibres-comprising carbon networks as conductive additives according to the invention (‘carbon networks’) has been compared with the performance of lithium-ion batteries for which their anodes comprised only artificial graphite (AG) without additives and those comprising AG in combination with conductive carbon black (Super C65) as conductive additive. Two grades of carbon networks are used, here below addressed as A and B. Both Grade A and Grade B have been manufactured in furnace black reactor by using the same feedstock. The residence times of Grade A and B were in the ranges 400-800 milliseconds and 10-100 milliseconds (based on theoretical model), respectively.

Grade D and Grade C have also been manufactured in a furnace carbon black reactor by using the same feedstock and same residence times than A and B, respectively. Grade D is produced by using 30% higher feed rate compared to A, while Grade C is produced by using 30% lower feedstock rate compared to B. Experiments reported herein have been carried out with anodes, but the work and results are not expected being any different for cathodes for lithium-ion batteries.

### Anode (& Conductive Additive) Paste Preparation

PVDF (300 mg) was dissolved in NMP (7.000 g) using mechanical stirring for 45 min. Conductive additive (300 mg) was added and glass beads 4 mm diameter (1.0 g) are added to increase shear during mixing. The paste was mixed in a Speedmixer (Hauschildt) for 2 min at 2500 rpm, followed by another 10 min at 2500 rpm to obtain a dispersion. Artificial Graphite (6.00 g) was added and mixed in a Speedmixer (Hauschildt) for 2 min at 2500 rpm, followed by another 10 min at 2500 rpm to obtain the anode paste.

TABLE 1
Anode paste preparation

| | Artificial | | | | |
|---|---|---|---|---|---|
| | Graphite | Conductive | | PVDF | NMP |
| Anode | [g] | Additive | [mg] | [mg] | [g] |
| AG | 6.000 | n.a. | n.a. | 300 | 7.000 |
| AG/Super C65 | 6.000 | Super C65 | 300 | 300 | 7.000 |
| AG/A | 6.000 | A | 300 | 300 | 7.000 |
| AG/B | 6.000 | B | 300 | 300 | 7.000 |
| AG/C | 6.000 | C | 300 | 300 | 7.000 |
| AG/D | 6.000 | D | 300 | 300 | 7.000 |

The viscosity increase of the anode paste when using Super C65 as a conductive additive was considerably higher when compared to using same amounts of A and B instead. In fact, it was not possible to cast the anode paste, when the proportion of Super C65 in the anode paste composition was increased beyond 400 mg. However, a castable paste could still be obtained when A content was increased to 600 mg (keeping the masses of the other components constant). Hence, this showed there are clear advantages in terms of achieving higher loadings of conductive additive, and processing could be improved, if networks of the invention were used. A castable paste was obtained with C and D.

### Anode Preparation

A glass plate was thoroughly cleaned and dried using acetone. Drops of NMP are added to the glass plate in order to hold the copper foil (>99.9% Cu, thickness 10 micron, Nanografi) in place by capillary forces. The copper foil was cleaned using NMP and subsequently dried using a lint free cloth. The anode paste was cast using a doctor blade that was set at different heights as specified in the tables. The glass plate was transferred to an oven and kept overnight at 110° C. The anode was punched (14 mm diameter).

### Half-Cell Preparation

A spring, spacer, lithium disc (15.6 mm), drops of electrolyte (EC/EMC 1:1 1M LiPF₆), electrolyte (EC/EMC 1:1 1M LiPF6) soaked separator (20 mm), drops of electrolyte (EC/EMC 1:1 1M LiPF₆) and downfacing anode are crimped together in a CR2032 coin cell inside a glovebox. After extraction of the half-cell from the glovebox, it was immediately used for electrochemical testing. The anode materials are characterised in Table 2:

TABLE 2
Characterisation of anode materials

| | | Artificial | | | | |
|---|---|---|---|---|---|---|
| Characterisation | | Graphite | Grade A | Grade B | Grade C | Grade D |
| d-spacing (XRD) | nm | 0.335 ¹ | 0.362 | 0.364 | 0.371 | 0.369 |
| Pore Volume (N2 | [mL/g] | | | 0.746 | | |
| physisorption) | | | | | | |
| Pore Volume (MIP) | [mL/g] | | 0.61 | 0.66 | 0.66 | 0.74 |
| Surface Area (BET) | [m²/g] | ≤4.2 | 41 | 110 | 189 | 49 |
| Pore Diameter (MIP) | [nm] | | 70 | 20 | 20 | 70 |
| Pore Diameter (BET) | [nm] | | | | | |
| Particle Size | [nm] | | 249 | 35 | 44 | 196 |
| Distribution (DCP | | | | | | |
| Δ50, ISO 15825: 2017) | | | | | | |
| Aggregate size | [μm] | | 8.3 | 13.9 | 4.9 | 6.10 |
| distribution (Laser | | | | | | |
| Diffraction - 2 bars | | | | | | |
| Δ50) | | | | | | |
| Particle diameter | [nm] | | 74 | 30 | 35 | 61 |
| (SEM) | | | | | | |
| pH | | | 7.0 | 5.3 | 6.2 | 6.4 |

¹ Delhaes, P. (2001). Graphite and Precursors. CRC Press. ISBN 978-90-5699-228-6.

### a. Capacity

The fresh half-cell was discharged at a constant discharge current of 0.2 C (discharge in ˜5 hours), until the potential was dropped to 0.01 V. The half-cell was then kept at 0.01 V for 1 hour, or until the discharge current was <1% of initial discharge current. The half-cell was then left to equilibrate for 1 hour, before being charged at 0.2 C (charge in ˜5 hours) to 2.0 V. The half-cell was then kept at 2.0 V for 1 hour, or until the charge current was <1% of initial charge current. Capacity was calculated by multiplying the charging current by the time it takes to reach 2.0 V, including the current that was required to keep the potential at 2.0 V for 1 hour.

TABLE 3
Capacity of lithium-ion battery anodes comprising carbon nanofibres-comprising
carbon networks as conductive additives according to the invention.

| | Anode | | | | | | |
|---|---|---|---|---|---|---|---|
| | loading | PVDF | Doctor Blade | | | | |
| | [mg | content | Height | C-rate | Capacity | | |
| Carbon | carbon] | [wt. %] | [micron] | [C] | [# cycle] | [% AG]* | [mAh/g] |
| AG | 4.95 | 4.76 | 100 | 0.2 | 2 | 96.0 | 325.2 |
| AG/Grade A | 3.95 | 4.60 | 100 | 0.2 | 2 | 94.1 | 318.6 |
| AG/Grade C | 4.90 | 4.54 | 100 | 0.2 | 4 | 96.7 | 327.5 |
| AG/Grade D | 5.33 | 4.56 | 100 | 0.2 | 4 | 93.7 | 317.4 |

*[% AG] = measured specific capacity after # cycles/338.6 mA · h/g * 100%

### b. Cyclability (Cycle Life)

The fresh half-cell was discharged at a constant discharge current of 0.2 C (discharge in ˜5 hours), until the potential was dropped to 0.01 V. The half-cell was then kept at 0.01 V for 1 hour, or until the discharge current was <1% of initial discharge current. The half-cell was then left to equilibrate for 1 hour, before being charged at 0.2 C (charge in ˜5 hours) to 2.0 V. The half-cell was then kept at 2.0 V for 1 hour, or until the charge current was <1% of initial charge current. This was a single cycle. The cycle was repeated for as many times as possible (in view of time) and the decrease in capacity was monitored as a function of cycles.

FIG. 3 shows that the specific capacity when using an AG anode (squares) decreases dramatically and steadily with the cycle number, while the specific capacity when using an AG/A anode (crosses) decreases less steeply from the outset, and actually equilibrates after 100 cycles. FIG. 5 shows that the specific capacity for AG/C (crosses) and AG/D (triangles) anodes does not decrease steeply. From 20 to 100 cycles the capacity is maintained around 95%. This behaviour is an improvement over AG anodes (FIG. 3) that showed loss of 50% capacity at around 50 cycles. This demonstrates the higher cycle life achieved when using the anodes according to the invention. These results are also summarized in Table 4.

TABLE 4
Cyclability (life-time) of lithium-ion battery anodes comprising carbon nanofibres-
comprising carbon networks as conductive additives according to the invention.

| | Anode | | Doctor | | | Specific | Specific | |
|---|---|---|---|---|---|---|---|---|
| | loading | PVDF | Blade | | | Capacity | Capacity | Capacity |
| | [mg | content | Height | C-rate | [# last | [mAh/g | mAh/g | retention |
| Carbon | carbon] | [wt %] | [micron] | [C] | cycle] | of carbon] * | of carbon] ** | [%] *** |
| AG | 4.95 | 4.76 | 100 | 0.2 | 69 | 325.2 | 74.5 | 22.9 |
| AG/Grade A | 3.95 | 4.60 | 100 | 0.2 | 223 | 318.6 | 225.5 | 70.8 |
| AG/Grade C | 4.90 | 4.54 | 100 | 0.2 | 101 | 327.5 | 315.0 | 96.2 |
| AG/Grade D | 5.33 | 4.56 | 100 | 0.2 | 101 | 317.4 | 310.6 | 97.9 |

* [% AG] = measured specific capacity after # cycles/338.6 mA · h/g * 100%

### c. Charge/Discharge Rate: Cyclability at Different C-Rates

Lithium ion battery anodes were prepared according to Table 5:

TABLE 5
lithium-ion battery anodes for experiment
on cyclability at different C-rates.

| | carbon | Binder | Doctor Blade |
|---|---|---|---|
| | loading | content | Height |
| Sample | [mg] | [wt. %] | [micron] |
| AG/Grade A | 4.13 | 4.60 | 100 |
| AG/Grade B | 3.41 | 4.56 | 100 |
| AG | 5.11 | 4.75 | 100 |
| AG | 6.35 | 4.81 | 100 |
| AG/Grade C | 5.33 | 4.54 | 100 |
| AG/Grade D | 5.27 | 4.56 | 100 |

The fresh half-cell was discharged at a constant discharge current of 0.5 C (discharge in ˜2 hours), until the potential was dropped to 0.01 V. The half-cell was then kept at 0.01 V for 1 hour, or until the discharge current was <1% of initial discharge current. The half-cell was then left to equilibrate for 1 hour, before being charged at 0.5 C (charge in ˜2 hours) to 2.0 V. The half-cell was then kept at 2.0 V for 1 hour, or until the charge current was <1% of initial charge current. This cycle was repeated 10 times. Then the discharge and charge current are changed to 1.0 C ((dis) charge in ˜1 hour), which was repeated 10 times. Then the discharge and charge current are changed to 5.0 C ((dis) charge in 12 min), which was repeated 10 times. Then the discharge and charge current are changed to 10.0 C ((dis) charge in 6 min), which was repeated 10 times. Then the discharge and charge current are changed back to 0.5 C ((dis) charge in ˜2 hour), which was repeated 10 times, in order to observe the decrease in capacity after these 55 cycles. For Grade C, Grade D, and AG, after the 10 cycles at 10.0 C, the discharge and charge current are changed to 20.0 C ((dis) charge in 3 min), which was repeated 10 times. Then the discharge and charge current are changed back to 0.5 C ((dis) charge in ˜2 hour), which was repeated 10 times, in order to observe the decrease in capacity after these 66 cycles.

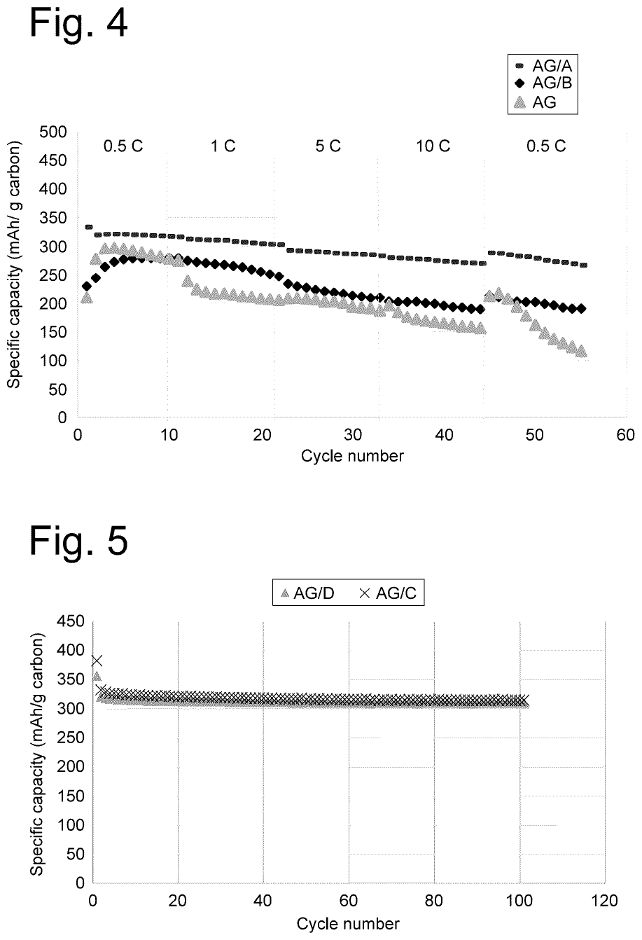

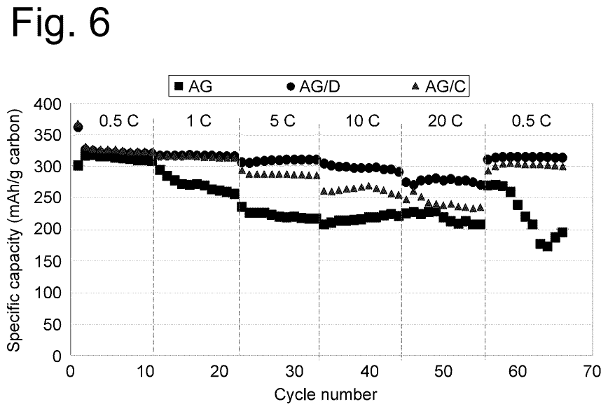

The results of these experiments are shown in FIG. 4 and FIG. 6. FIG. 4 shows that the specific capacity of the AG/Grade B anode (squares) is mostly superior to that of the AG anode (triangles), while the specific capacity of the AG/Grade A (dashes) is substantially higher than that of the AG anode (triangles). FIG. 6 shows that that for AG/Grade C (triangles) and Grade D (circles) the specific capacity decreased less than for AG (squares) at 10 C. Even up to 20 C, the capacity of AG/Grade C and AG/Grade D was superior than AG. When C-rate was reduced from 20 C to 0.5 C, it was still possible to recover 95-100% of the initial capacity for AG/Grade C and AG/Grade D. In contrast, it was not possible to recover the initial capacity of AG.

1.-20. (canceled)

21. A lithium or sodium battery anode and/or cathode comprising porous, chemically interconnected, carbon nanofibers-comprising carbon networks as conductive additive material, the lithium or sodium battery anode and/or cathode,
wherein the carbon nanofibers in the carbon networks are covalently bonded,
wherein the carbon networks form an intraparticle porous network wherein the carbon nanofibers are interconnected to other carbon nanofibers in the network by chemical bonds via junctions, wherein the pores in the network have an intraparticle pore diameter size of 5-150 nm using Mercury Intrusion Porosimetry according to ASTM D4404-10, wherein the carbon nanofibers have an average aspect ratio of fibre length-to-thickness of at least 2.

22. The lithium or sodium battery anode and/or cathode according to claim 21, wherein the carbon nanofibers-comprising carbon networks represent 0.1-20 wt % of the total mass of the cathode, and/or wherein the carbon-nanofibre comprising carbon networks represent 0.1-10 wt % of the total mass of the anode.

23. The lithium or sodium battery anode and/or cathode according to claim 21, wherein the carbon nanofibers have a d-spacing in the range of 0.340-0.5 nm.

24. The lithium or sodium battery anode and/or cathode according to claim 21, wherein the anode and/or the cathode also comprises 0.1-10 wt % of a binder.

25. The lithium or sodium battery anode and/or cathode according to claim 21, wherein the cathode and/or anode also comprises 0.1-10 wt % of one or more further conductive additives selected from conductive carbon black, Super P, acetylene black, carbon nanofibers, and carbon nanotubes.

26. The lithium battery cathode according to claim 21, wherein the cathode comprises a sulfur composite comprising porous, chemically interconnected, carbon nanofibres-comprising carbon networks as conductive additive material.

27. The battery anode according to claim 21, wherein the battery is a lithium battery, wherein the anode comprises 90-99.9 wt. % of an additional active material, wherein the additional active material is graphite, silicon, a silicon-based compound or a combination thereof.

28. The battery anode according to claim 27, wherein the additional active material is silicon, a silicon-based compound, or a combination thereof, wherein silicon, the silicon-based compound, or combination thereof are mixed with the carbon nanofibres-comprising carbon networks in the anode or the carbon nanofibres-comprising carbon networks are coated with silicon, the silicon-based compound, or combination thereof.

29. A rechargeable lithium or sodium battery comprising the anode and/or cathode according to claim 21.

30. The rechargeable lithium or sodium battery according to claim 29, being a lithium-ion or sodium-ion battery.

31. The lithium or sodium battery anode and/or cathode according to claim 21, wherein the carbon networks are obtainable by a process for producing crystalline carbon networks in a reactor which contains a reaction zone and a termination zone, by injecting a water-in-oil or bicontinuous micro-emulsion comprising metal catalyst nanoparticles, into the reaction zone which is at a temperature of above 600° C., to produce crystalline carbon networks, transferring these networks to the termination zone, and quenching or stopping the formation of crystalline carbon networks in the termination zone by spraying in water.

32. A battery-powered device comprising the lithium or sodium battery anode and/or cathode according to claim 21, the lithium or sodium battery being a lithium-ion or sodium-ion battery.

33. The device according to claim 32, which is an smartphone, a laptop, a digital camera, a camcorder, a medical and communication system, an Uninterruptible Power Supply (UPS), a power plant energy storage device or an electric and/or hybrid vehicle.
